(19) United States
(12) Patent Application Publication
(10) Pub. No.: US 2015/0242797 A1
(43) Pub. Date: Aug. 27, 2015

(54) METHODS AND SYSTEMS FOR EVALUATING PERFORMANCE

(71) Applicant: University of Alaska Anchorage, Anchorage, AK (US)

(72) Inventors: Bogdan Hoanca, Anchorage, AK (US); Timothy Smith, Anchorage, AK (US); Kenrick Mock, Anchorage, AK (US)

(21) Appl. No.: 14/633,692

(22) Filed: Feb. 27, 2015

Related U.S. Application Data
(60) Provisional application No. 61/945,462, filed on Feb. 27, 2014.

(51) Int. Cl. G06Q 10/06

(52) U.S. Cl. CPC G06Q 10/06398

(57) ABSTRACT

Methods and systems for evaluating performance comprise receiving, by a computer system, first movement data of a first part of a user, wherein the user is performing a task. A first plurality of metrics can be determined based on the first movement data of the first part. A level of proficiency of the user performing the task is determined using a trained classifier based on the first plurality of metrics.

### CROSS REFERENCE TO RELATED PATENT APPLICATION

This application claims priority to U.S. Provisional Application No. 61/945,462 filed Feb. 27, 2014, herein incorporated by reference in its entirety.

### STATEMENT REGARDING FEDERALLY SPONSORED RESEARCH

This invention was made with government support under grant NSF MRI RUI 1126896 awarded by the National Science Foundation. The government has certain rights in this invention.

### BACKGROUND

Performance evaluation is ubiquitous with many professions, athletics, learning, music, and the like. In certain situations, a subject is evaluated based on their movements. Often, the evaluation of the subject is performed by a human, which can lead to inconsistencies in the evaluation. Furthermore, access to a human evaluator may be difficult and self-evaluation may be impossible or inaccurate depending on the task and skill level of the subject being evaluated. These and other shortcomings are addressed in the present disclosure.

### SUMMARY

It is to be understood that both the following general description and the following detailed description are exemplary and explanatory only and are not restrictive, as claimed. Provided are methods and systems for evaluating performance. In an aspect, a data collector can receive first movement data of a first part of a user. The movements of the user while the user is performing a task can be tracked and movement data can be derived from the tracked movements. In an aspect, the data collector can determine a first plurality of metrics based on the first movement data of the first part. In an aspect, the data collector can determine a level of proficiency of the user during the task using a trained classifier based on the first plurality of metrics. For example, the part of a user can be an eye, a hand, a leg, an arm, a torso, a head, combinations thereof, and the like. The task can be, for example, one or more of, performing a movement, using a tool, using an instrument, using a musical instrument, playing a video game, reading text, typing text, reading a foreign language, and typing a foreign language.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is an exemplary operating environment;

FIG. 2 is another exemplary operating environment;

FIG. 3 is a flow diagram illustrating an exemplary method;

FIG. 4 is a flow diagram illustrating an exemplary method;

FIG. 5 is a flow diagram illustrating an exemplary method;

FIG. 6 is illustrates results from application of the methods and systems; and

FIG. 7 is an exemplary operating environment.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, values, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus (e.g., smart phone) to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Provided herein are methods and systems for evaluating performance. In an aspect, one or more users can have one or more body parts (e.g., an eye, a hand, a leg, an arm, a torso, a head) tracked (e.g., visually, spatially, etc. . . . ). Data can be generated that reflects the tracking. The generated data can be analyzed to determine one or more movements, combinations of movements, and the like that are indicative of one or more levels of performance. In an aspect, the methods and systems can determine one or more metrics indicative of performance. For example, movements can be determined to correlate to a low level of performance, a medium level of performance, a high level of performance and the like. In an aspect, a performance score can be from 1 to 10, wherein a higher level performance can receive a higher number score than a lower level performance. In a further aspect, one or more users regarded as experts in a particular field can be tracked and the resultant data can be used to determine relative performance levels.

In an aspect, one or more spatial factors of a tool can be tracked in conjunction with tracking one or more body parts. For example, data can be generated that reflects the spatial position (or configuration status) of one or more tools (e.g., instruments, devices, and the like) relative to one or more body parts of a user. The generated data can be analyzed to determine one or more movements, combinations of movements, and the like in combination with spatial factors of the tool being used by the user that are, in combination, indicative of one or more levels of performance. For example, movements and spatial factors can be determined to correlate to a low level of performance, a medium level of performance, a high level of performance, and the like. In a further aspect, one or more users regarded as experts in a particular field can be tracked in combination with instrument usage and the resultant data can be used to determine relative performance levels.

In an aspect, provided are exemplary methods and systems for evaluating performance related to the eye. However, the present disclosure is not limited to analysis of the eye. Tracking of other body parts is also specifically contemplated.

The systems and methods described herein can track a body part of a user while the user is performing a task. In an aspect, the movement of a user's eyes can be tracked while the user sight-reads a musical score and plays a musical instrument (e.g., piano). In another example, a golfer's eyes can be tracked as the golfer swings a golf club. In another example, the movement of a tool such as a hammer can be tracked in relation to a body part of a subject using the tool. Returning to the example of the user's eyes being tracked, the systems and methods described herein can receive eye movement data for a plurality of users. The systems and methods can use the received eye movement data to determine a plurality of metric sets. For example, a metric set can comprise a plurality of metrics such as determining a tempo, a total backtrack duration, a backtrack count, a fixation mean, a fixation maximum, a uniformity, a non-uniformity, a velocity, an acceleration, a range of motion, beats per unit time (e.g., minute), a vibration spectrum, note accuracy, audio quality, combinations thereof, and the like associated with each user. The system can select one or more of the plurality of metric sets that is ideal for classifying a pattern. In an aspect, the system can select a tempo that would be optimal and use that tempo as the pattern against which other users can be measured.

The systems and methods described herein can track a sequence of movements of one or more parts of a user, wherein the user is performing a task, such as sight-reading and playing a piano, playing sports and using a piece of sports equipment, reading a book, and the like. For example, the part of a user can be an eye, a hand, a leg, an arm, a torso, a head, combinations thereof, and the like. In an aspect, a tool used by the user can be tracked as well as one or more parts of the user. A plurality of metrics based on the tracked sequence of movements can be determined. In an aspect, the determined plurality of metrics can include a tempo, a total backtrack duration, a backtrack count, a fixation mean, a fixation maximum, a uniformity, a non-uniformity, a velocity, an acceleration, a range of motion, beats per unit time (e.g., minute), a vibration spectrum, note accuracy, audio quality, combinations thereof, and the like. A trained classifier can classify a sight-reading ability of a user playing a piano based on comparing the plurality of metrics against a pattern. In an aspect, the pattern can be obtained from a plurality of metrics of one or more users regarded as experts in a particular field. In an aspect, classifying the sight-reading ability of the user playing the piano can comprise evaluating and scoring the sight-reading ability of the user playing the piano. In an aspect, the tempo can be compared against a tempo selected as a pattern. In an aspect, the tempo selected as a pattern can be an “ideal” tempo.

One metric the systems and methods described herein can consider is backtrack duration. Backtrack duration can consider the total duration of all the fixation points within areas of interest (AOIs) where a previous fixation was in a higher numbered AOI. Because a music piece can progress through AOIs in increasing order, this can be a measure of the time spent in backtracking fixations. In an aspect, an AOI can be a musical note, symbol, measure, sentence, word, and the like on a visual display. In an aspect, backtrack duration can be a total duration for the fixations that occur in areas of interest that have a sequence number lower than the that of a previous fixation point.

Another metric the systems and methods described herein can consider is backtrack count. Backtrack count can be a count of the number of backtracking events (regardless of duration). Backtracking events can be a fixation where the previous fixation was in a higher numbered AOI in a sequence.

In another aspect, a metric the systems and methods described herein can consider is fixation AOI mean. Fixation AOI mean can be the mean duration of a fixation event within the AOIs. A better sight-reader may fixate for a shorter time, while a worse sight-reader may fixate for a longer time. However, skilled sight-readers reading easy music simply need to fixate less. Therefore, fixations may appear to be longer due to lateral peripheral skills of the user.

Another metric the systems and methods described herein can consider is fixation AOI max. Fixation AOI max can be the longest duration of a fixation event within the AOIs. A better sight-reader may fixate for a relatively constant time and keep tempo, compared to a worse sight-reader that may make a mistake and spend a longer time fixating on the measure where the mistake occurred.

In a further aspect, another metric the systems and methods described herein can consider is non-uniformity. A proficient sight-reader may have a great eye-hand span. Eye-hand span can be a metric, which is the ability of a player to sight-read a number of beats ahead of a measure the player is currently playing. Having a great eye-hand span can allow a player to read notes further ahead of the notes the player is playing. In an aspect, evaluating whether a player is looking ahead can be determined by comparing a current AOI being fixated to an AOI that would be fixated in an expected case. The AOI that would be fixated to in an expected case would be based on the expected task. For instance, if a user is playing a first note on a musical instrument while the user is fixated on a second note that is 5 notes subsequent from the first note played and the first note being played is an expected note, then the user has a non-uniformity or eye-hand span of five notes. In an aspect, non-uniformity can be calculated as a weighted sum of AOIs in sequence in an actual performance multiplied by the duration of each fixation, minus the same weighted sum of AOIs in an expected sequence (AOIs played in an increasing order and with an identical duration for each AOI measure). In an aspect, non-uniformity can be a measure of deviations of a current performance from an expected performance.

The number and duration of regressions can be a reliable measure of the sight-reading abilities of the subject. A human metric associated with regressions can involve audible backtracking (notes that are played incorrectly, and then replayed correctly by a beginner) while a plurality of eye tracking metrics associated with regressions can infer regression from a player's gaze returning to a previous AOI.

Another metric can be playback speed. Playback speed can be the ability to follow a consistent and/or fairly fast beat. A metric associated with playback speed can be a tempo. Tempo can be metronome beats per minute for a musical piece. A machine-extracted metric associated with playback speed can be the tempo. In an aspect, a machine-extracted metric associated with playback speed can be an inverse of the tempo.

In an aspect, an extracted metric associated with playback speed can be a number of variations in a tempo. A number of variations in a tempo can be extracted with a musical instrument digital interface (MIDI) enabled device, by comparing an ideal tempo in a musical score with an actual tempo in a plurality of notes played by a user.

Eye-hand span can be another metric, which is the ability of a player to sight-read a number of beats ahead of a measure the player is currently playing. A machine-extracted metric associated with eye-hand span can be a measure of a departure of a fixation on an actual AOI in relation to a fixation on an AOI corresponding to a plurality of musical notes currently being played. A MIDI enabled device can be used to determine an AOI of music currently being played, while an eye-tracker can be used to determine the AOI currently being fixated by a user's eye.

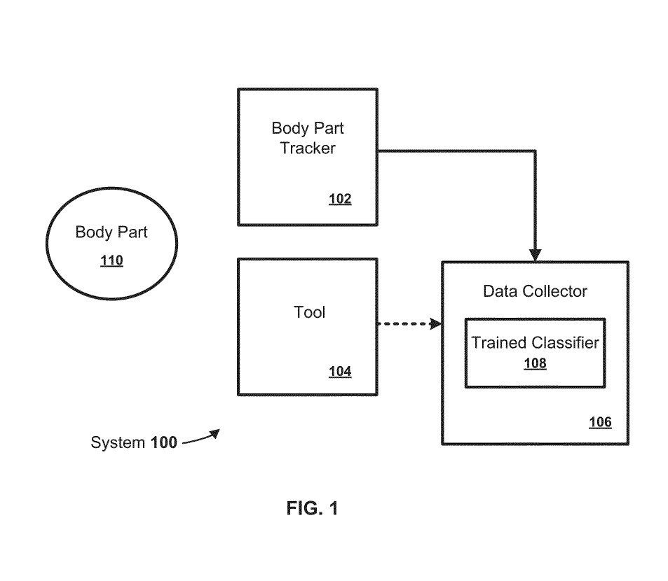

FIG. 1 illustrates various aspects of an exemplary environment in which the present methods and systems can operate. In one aspect of the disclosure, a system 100 can be configured to track a body part 110 and compare the measurements against a trained classifier 108. A body part tracker 102 can track the movement of the body part 110. In an aspect, the body part tracker 102 can be, for example, an eye tracking device, a camera (including a computer connected camera and/or a camera on a smartphone), a monitor (including a heart-rate monitor), a sensor (including an accelerometer based sensor, potentiometer, combinations thereof, and the like), a device including one of the above (e.g., a smartphone with a built in accelerometer), combinations thereof, and the like. In a further aspect, the body part tracker 102 can track the movement of one or more eyes. In an aspect, the body part tracker 102 can track the movement of one or more hands. In an aspect, the body part tracker 102 can track the movement of one or more feet. In an aspect, the body part tracker 102 can track the rate of movement of a body part. In a further aspect, the body part tracker 102 can track the rate of a heartbeat. In an aspect, the body part tracker 102 can provide data to a data collector 106.

The body part tracker 102 can track the movement of a user while the user is using a tool 104. In an aspect, the body part tracker 102 can track the movement of a body part that is using the tool 104. In an aspect, the body part tracker 102 can track the movement of a body part that is not using the tool 104. In an aspect, the tool 104 can be one or more of a musical instrument, a medical instrument, a vehicle control, a sport implement (e.g., racket, golf club, a bat), a tool (e.g., a wrench, a screw driver, a hammer), and the like. In an aspect, the musical instrument can be one or more of a piano, a keyboard, a set of drums, and a guitar, and the like. In an aspect, the tool 104 can comprise a user interface input device. In a further aspect, the tool 104 can comprise one or more of a keyboard, a joystick, a mouse, a joypad, a joystick, a motion sensor, a microphone, a controller, a remote control, and the like. In an aspect, the tool 104 can comprise an output device. In a further aspect, the tool 104 can comprise one or more of a visual display, an audio speaker, and a device with tactile output. In an aspect, the tool 104 can optionally provide data to a data collector 106.

The data collector 106 can collect data from the body tracker 102 and/or the tool 104. As an example, the data can include movement data of a body part being tracked and spatial factors of the tool 104. For example, spatial factors can be data that reflects the spatial position (or configuration status) of one or more tools (e.g., instruments, devices, and the like) relative to one or more body parts of a user. The data collector 106 can determine a plurality of metrics from the data. In an aspect, the data collector 106 can determine one or more of the following metrics: a total backtrack duration, a backtrack count, a fixation mean, a fixation maximum, a uniformity, a non-uniformity, a velocity, an acceleration, a range of motion, beats per unit time (e.g., minute), a vibration spectrum, a note accuracy, an audio quality, combinations thereof, and the like. In an aspect, the data collector 106 can comprise a trained classifier 108. In an aspect, the trained classifier 108 can comprise patterns against which the metrics can be measured. For example, the trained classifier 108 can identify correlation patterns and features of a performance (e.g. music performance). Examples of trained classifiers 108 can comprise note accuracy algorithms that can compare expected notes in a musical piece to actual notes played, movement tracking algorithms that compare a user's movement to an ideal movement for a task such as a swing of a baseball bat, tennis racket, golf club, and the like, other comparison algorithms that compare a measured metric to an ideal metric, and other machine learning classifiers as appropriate to the task at hand.

A level of proficiency can be determined using the trained classifier 108 based on the plurality of metrics. In an aspect, a data collector 106 can use a trained classifier 108 to determine the level of proficiency of the user performing the task. The trained classifier 108 can compare the plurality of metrics to a pattern. In an aspect, the pattern can be an “ideal” or “optimal” performance of the task. In an aspect, the pattern can be obtained from a plurality of metrics of one or more users regarded as experts in a particular field. The trained classifier 108 can determine the level of proficiency based on the extent the plurality of metrics matches the pattern. If the plurality of metrics is substantially identical to that of the pattern, then the level of proficiency is high. If the plurality of metrics deviates from the pattern substantially, then the level of proficiency can be low. In an aspect, the level of proficiency can be based on a predetermined percentage of accuracy between the plurality of metrics and the pattern.

The trained classifier 108 and other methods and systems can employ Artificial Intelligence techniques such as machine learning and iterative learning to determine a level of proficiency. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning). The machine learning algorithms can be supervised and unsupervised. Examples of unsupervised approaches can include clustering, anomaly detection, self-organizing map, combinations thereof, and the like. Examples of supervised approaches can include regression algorithms, classification algorithms, combinations thereof, and the like.

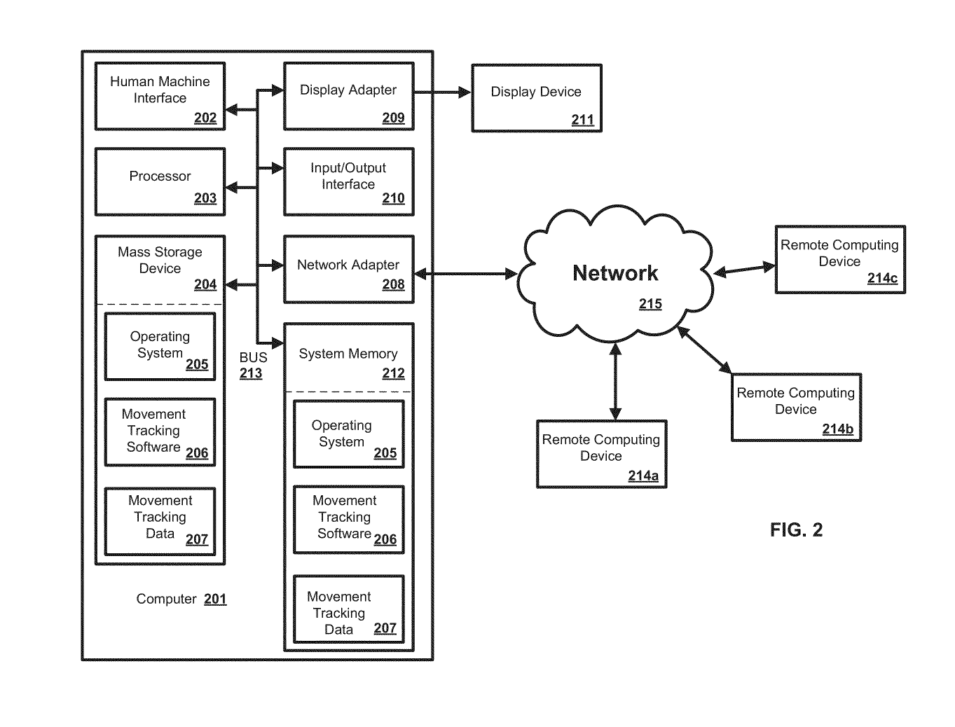

In an exemplary aspect, the methods and systems can be implemented on a computer 201 as illustrated in FIG. 2 and described below. By way of example, data collector 106 of FIG. 1 can be a computer as illustrated in FIG. 2. Similarly, the methods and systems disclosed can utilize one or more computers to perform one or more functions in one or more locations. FIG. 2 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, tablet computers, smartphones, dedicated hardware, for example, but not limited to, field-programmable gate array based computers, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer 201. The components of the computer 201 can comprise, but are not limited to, one or more processors or processing units 203, a system memory 212, and a system bus 213 that couples various system components including the processor 203 to the system memory 212. In the case of multiple processing units 203, the system can utilize parallel computing.

The system bus 213 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 213, and all buses specified in this description can also be implemented over a wired or wireless network connection and each of the subsystems, including the processor 203, a mass storage device 204, an operating system 205, movement tracking and performance evaluation software 206, movement tracking and performance evaluation data 207, a network adapter 208, system memory 212, an Input/Output Interface 210, a display adapter 209, a display device 211, and a human machine interface 202, can be contained within one or more remote computing devices 214a,b,c at physically separate locations, connected through buses of this form, in effect implementing a fully distributed system.

The computer 201 typically comprises a variety of computer readable media. Exemplary readable media can be any available media that is accessible by the computer 201 and comprises, for example and not meant to be limiting, both volatile and non-volatile media, removable and non-removable media. The system memory 212 comprises computer readable media in the form of volatile memory, such as random access memory (RAM), and/or non-volatile memory, such as read only memory (ROM). The system memory 212 typically contains data such as movement tracking and performance evaluation data 207 and/or program modules such as operating system 205 and movement tracking and performance evaluation software 206 that are immediately accessible to and/or are presently operated on by the processing unit 203.

In another aspect, the computer 201 can also comprise other removable/non-removable, volatile/non-volatile computer storage media. By way of example, FIG. 2 illustrates a mass storage device 204 which can provide non-volatile storage of computer code, computer readable instructions, data structures, program modules, and other data for the computer 201. For example and not meant to be limiting, a mass storage device 204 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 204, including by way of example, an operating system 205 and movement tracking and performance evaluation software 206. Each of the operating system 205 and movement tracking and performance evaluation software 206 (or some combination thereof) can comprise elements of the programming and the movement tracking and performance evaluation software 206. Movement tracking and performance evaluation data 207 can also be stored on the mass storage device 204. Movement tracking and performance evaluation data 207 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computer 201 via an input device (not shown). Examples of such input devices comprise, but are not limited to, a keyboard, pointing device (e.g., a “mouse”), a microphone, a joystick, a scanner, tactile input devices such as gloves, and other body coverings, and the like. Further examples of input devices comprise the tool 104 and the body part tracker 102. These and other input devices can be connected to the processing unit 203 via a human machine interface 202 that is coupled to the system bus 213, but can be connected by other interface and bus structures, such as a parallel port, game port, an IEEE 1394 Port (also known as a Firewire port), a serial port, or a universal serial bus (USB).

In yet another aspect, a display device 211 can also be connected to the system bus 213 via an interface, such as a display adapter 209. It is contemplated that the computer 201 can have more than one display adapter 209 and the computer 201 can have more than one display device 211. For example, a display device can be a monitor, an LCD (Liquid Crystal Display), or a projector. In addition to the display device 211, other output peripheral devices can comprise components such as speakers (not shown) and a printer (not shown) which can be connected to the computer 201 via Input/Output Interface 210. Any step and/or result of the methods can be output in any form to an output device. Such output can be any form of visual representation, including, but not limited to, textual, graphical, animation, audio, tactile, and the like. The display 211 and computer 201 can be part of one device, or separate devices.

The computer 201 can operate in a networked environment using logical connections to one or more remote computing devices 214a,b,c. By way of example, a remote computing device can be a personal computer, portable computer, smartphone, a server, a router, a network computer, a peer device or other common network node, and so on. Logical connections between the computer 201 and a remote computing device 214a,b,c can be made via a network 215, such as a local area network (LAN) and/or a general wide area network (WAN). Such network connections can be through a network adapter 208. A network adapter 208 can be implemented in both wired and wireless environments. Such networking environments are conventional and commonplace in dwellings, offices, enterprise-wide computer networks, intranets, and the Internet.

For purposes of illustration, application programs and other executable program components such as the operating system 205 are illustrated herein as discrete blocks, although it is recognized that such programs and components reside at various times in different storage components of the computing device 201, and are executed by the data processor(s) of the computer. An implementation of movement tracking and performance evaluation software 206 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

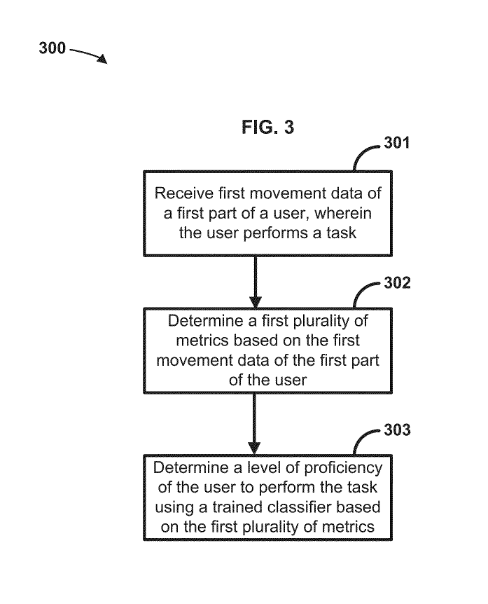

FIG. 3 is a flowchart illustrating an example method 300 for evaluating performance. At block 301, first movement data of a first part of a user can be derived and received from tracked movements of the user. The user can be performing a task while the first part of the user is being tracked. In an aspect, the movement of the user can be tracked by the body part tracker 102. The body part tracker 102 can derive first movement data from the tracked movements of the user and send the movement data to the data collector 106. The first movement data can be received by the data collector 106. As an example, the first part of a user can be an eye, a hand, a leg, an arm, a torso, a head, and the like, and combinations thereof. The task can be, for example, one or more of, performing a movement, using a tool, using an instrument, using a musical instrument, playing a video game, reading text, typing text, reading a foreign language, typing a foreign language, and the like. In an aspect, tracking a movement of a body part of a user can comprise tracking a movement of an object attached to the body part. For example, tracking a movement of a hand can comprise tracking a movement of a glove attached to the hand or tracking the movement of a head can include tracking the movement of a helmet. In an aspect, tracking the movement of a body part of a user can comprise tracking a movement of an object manipulated by the body part. For example, tracking a movement of a hand can comprise tracking a movement of the tool 104 being held by the hand.

At block 302, a first plurality of metrics based on the first movement data of the first part of the user can be determined. The first plurality of metrics can include a tempo, a total backtrack duration, a backtrack count, a fixation mean, a fixation maximum, a uniformity, a non-uniformity, a velocity, an acceleration, a range of motion, beats per unit time (e.g., minute), a vibration spectrum, note accuracy, an audio quality, and the like. In an aspect, the metrics can be determined by a data collector 106 that receives the first movement data from a body part tracker 102. In an aspect the data collector 106 can receive data from an object (e.g., tool 104). In an aspect, the data collector 106 can determine the plurality of metrics from the first movement data.

In an aspect, determining the first plurality of metrics based on the first movement data of the first part can comprise tracking a position of the first part. In an aspect, a body part tracker 102 can track a depth of the first part, relative to the body part tracker 102. In an aspect, the body part tracker 102 can track a horizontal position of the first part, relative to the body part tracker 102. In an aspect, the body part tracker 102 can track a vertical position of the first part, relative to the body part tracker 102. In an aspect, the body part tracker 102 can track a composite of two or more of: a depth of the first part, relative to the body part tracker 102; a horizontal position of the first part, relative to the body part tracker 102; and a vertical position of the first part, relative to the body part tracker 102.

In an aspect, determining the first plurality of metrics based on the first movement data of the first part can comprise tracking a velocity of the first part. In an aspect, a body part tracker 102 can track a velocity of the first part in a direction towards or away from the body part tracker 102. In an aspect, the body part tracker 102 can track a velocity of the first part in a horizontal direction relative to the body part tracker 102. In an aspect, the body part tracker 102 can track a velocity of the first part in a vertical direction relative to the body part tracker 102. In an aspect, the body part tracker 102 can track a composite of two or more of: a velocity of the first part in a direction towards or away from the body part tracker 102; a velocity of the first part in a horizontal direction relative to the body part tracker 102; and a velocity of the first part in a vertical direction relative to the body part tracker 102.

In an aspect, determining the first plurality of metrics based on the first movement data of the first part can comprise tracking an acceleration of the first part. In an aspect, a body part tracker 102 can track an acceleration of the first part in a direction towards or away from the body part tracker 102. In an aspect, the body part tracker 102 can track an acceleration of the first part in a horizontal direction relative to the body part tracker 102. In an aspect, the body part tracker 102 can track an acceleration of the first part in a vertical direction relative to the body part tracker 102. In an aspect, the body part tracker 102 can track a composite of two or more of: an acceleration of the first part in a direction towards or away from the body part tracker 102; an acceleration the first part in a horizontal direction relative to the body part tracker 102; and an acceleration of the first part in a vertical direction relative to the body part tracker 102.

At block 303, a level of proficiency of the user performing the task can be determined. The level of proficiency can be determined using a trained classifier (e.g., trained classifier 108) based on the first plurality of metrics. In an aspect, the data collector 106 can use the trained classifier 108 to determine the level of proficiency of the user performing the task. The trained classifier 108 can compare the first plurality of metrics to a pattern. In an aspect, the pattern can be an “ideal” performance of the task. In an aspect, the pattern can be obtained from a plurality of metrics of one or more users regarded as experts in a particular field. The trained classifier 108 can determine the level of proficiency based on the extent the first plurality of metrics matches the pattern. If the first plurality of metrics is substantially identical to that of the pattern, then the level of proficiency is high. If the first plurality of metrics deviates from the pattern substantially, then the level of proficiency can be low. In an aspect, the level of proficiency can be based on a predetermined percentage of accuracy between the first plurality of metrics and the pattern.

The methods can further comprise tracking a movement of a second part of the user that corresponds to the movement of the first part of the user, and determining a second plurality of metrics based on the movement of the second part. In an aspect, the body part tracker 102 can track movement and derive second movement data of the second part. The data collector 106 can receive the second movement data from the body part tracker 102. In an aspect, the second part of a user can be an eye, a hand, a leg, an arm, a torso, a head, and the like, and combinations thereof. As an example, if a user is playing piano, then the first part of the user can be one or both eyes and the second part of the user can be one or both hands. The movement of the hands of the user can correspond with the movement of the eyes of the user. In an aspect, the second plurality of metrics can include a tempo, a uniformity, a non-uniformity, a velocity, an acceleration, a range of motion, beats per unit time (e.g., minute), a vibration spectrum, audio quality, and the like. In an aspect, the movement of the second part relative to one or more user devices can be used to determine the second plurality of metrics.

In an aspect, any method for determining the first plurality of metrics based on movement of the first part can be used to determine the second plurality of metrics based on the movement of the second part.

In an aspect, a level of proficiency of the user performing the task can be determined by using the trained classifier 108 based on the first plurality of metrics and the second plurality of metrics. The trained classifier 108 can compare the first plurality of metrics to a first pattern. The trained classifier 108 can compare the second plurality of metrics to a second pattern. The first and second patterns can be obtained from an “ideal” performance of the task. In an aspect, the first pattern can be obtained from a plurality of metrics of a first part of one or more users regarded as experts in a particular field. The second pattern can be obtained from a plurality of metrics of a second part of a user regarded as an expert in the particular field when the first pattern is being obtained. The trained classifier 108 can determine the level of proficiency based on the extent the first plurality of metrics matches the first pattern and the second plurality of metrics matches the second pattern. If the first plurality of metrics is substantially identical to that of the first pattern and the second plurality of metrics is substantially identical to that of the second pattern, then the level of proficiency is high.

In an aspect, there could be several ways to perform a task at various abilities. For example, there could be several ways to perform the task at an expert level and several ways to perform a task at a novice level, and the like. In an aspect, the trained classifier 108 can be based on a model comprising a plurality of sets of one or more patterns. In an aspect, each set can have the first pattern and the second pattern. Each set of one or more patterns can be based on one or more users of various levels of proficiency in performing the task. A trained classifier 108 can include the plurality of sets of patterns so that the trained classifier 108 can differentiate between the various levels of proficiency.

The trained classifier 108 and other methods and systems can employ Artificial Intelligence techniques such as machine learning and iterative learning to determine a level of proficiency. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning). The machine learning algorithms can be supervised and unsupervised. Examples of unsupervised approaches can include clustering, anomaly detection, self-organizing map, combinations thereof, and the like. Examples of supervised approaches can include regression algorithms, classification algorithms, combinations thereof, and the like.

In an aspect, when determining a level of proficiency, a position of a first part of the user can be determined for a period of time by the data collector 106. In an aspect, movement of the second part relative to one or more user devices for the period of time can be detected by the body part tracker 102. Based on the position of the first part and the movement of the second part for the period of time, the data collector 106 can determine whether the performed activity of the second part of the user is an expected activity for the period of time.

In an aspect, when determining a level of proficiency based on the first plurality of metrics and the second plurality of metrics, a fixation point of the first part of the user can be determined for a period of time. In an aspect, the movement of the second part relative to one or more user devices for the period of time can be determined, tracked, and sent by the body part tracker 102 to the data collector 106. The data collector 106, based on the fixation point of the first part and the movement of the second part for the period of time, can determine whether the performed activity of the second part of the user is an expected activity for the period of time. In an aspect, the fixation point can be extracted automatically by the body part tracker 102. In an aspect, the fixation can be inferred from the data obtained by the body part tracker 102. For example, if the body part position does not change by more than a certain angular distance. In an example of the fixation point being an eye fixation point, the eye fixation point can help determine whether the user looked at information that was expected of the user to look at.

In an aspect, the methods can further comprise tracking one or more spatial factors of an instrument and determining a third plurality of metrics based on the one or more spatial factors. In an aspect, the instrument can provide spatial factors of the instrument to a data collector 106, which can receive the spatial factors and determine a third plurality of metrics. In an aspect, the third plurality of metrics can include a tempo, a uniformity, a non-uniformity, a velocity, an acceleration, a range of motion, beats per unit time (e.g., minute), a vibration spectrum, audio quality, and the like. The methods can further comprise determining a level of proficiency of the user performing the task using a trained classifier (e.g., trained classifier 108) based on the first plurality of metrics and the third plurality of metrics. The trained classifier 108 can compare the first plurality of metrics to a first pattern. The trained classifier 108 can compare the third plurality of metrics to a third pattern. The first and third patterns can be an “optimal” performance of the task and an “optimal” position of the instrument. In an aspect, the first pattern can be obtained from a plurality of metrics of one or more users regarded as experts in a particular field. The third pattern can be obtained from a plurality of metrics of an instrument used by the one or more users regarded as experts in a particular field when the first pattern is being obtained. The trained classifier 108 can determine the level of proficiency based on the extent the first plurality of metrics matches the first pattern and the third plurality of metrics matches the third pattern. If the first plurality of metrics is substantially identical to that of the first pattern and the third plurality of metrics is substantially identical to that of the third pattern, then the level of proficiency is high.

In an aspect, there could be several ways to perform a task with the instrument at various abilities. For example, there could be several ways to perform the task at an expert level and several ways to perform a task at a novice level, and the like. In an aspect, the trained classifier 108 can be based on a model comprising a plurality of sets of one or more patterns. In an aspect, each set can have the first pattern and the third pattern. Each set of one or more patterns can be based on one or more users of various levels of proficiency in performing the task. A trained classifier 108 can include the plurality of sets of patterns so that the trained classifier 108 can differentiate between the various levels of proficiency.

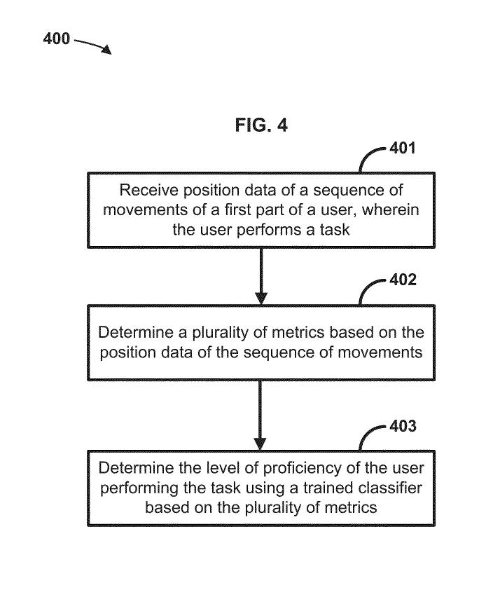

FIG. 4 is a flowchart illustrating an example method 400 for evaluating performance. In step 401, a sequence of movements of a first part of a user is tracked and position data of the sequence of movements is recorded when the user is performing a task. As an example, the first part of a user can be an eye, a hand, a leg, an arm, a torso, a head, and the like, and combinations thereof. The task can be, for example, one or more of, using a tool, using an instrument, using a musical instrument, playing a video game, reading text, typing text, reading a foreign language, and typing a foreign language. In an aspect, a body part tracker (e.g., body part tracker 102) can track the sequence of movement of the first part and gather position data based on the sequence of movements. The body part tracker 102 can send the position data to a data collector 106, which can receive the position data.

In an aspect, when tracking a sequence of movements of a first part of a user, the body part tracker 102 can determine a start (first) area of interest. As an example, the first part of the user can be one or more of the user's eyes. An area of interest may be an area on a visual display. The area can comprise a symbol, a musical measure, a note, a word, a sentence, a paragraph, a position of a tool, and the like. For example, for sight-reading a musical piece, a start area of interest can be the first measure of the musical piece. In an example of swinging a golf club, the start area of interest can be when the golfer begins a swing. The body part tracker 102 can also determine an end (last) area of interest. In the example of sight-reading, the end area of interest can be the last measure. In the example of swinging a golf club, the end area of interest can be when the golf club strikes the ball or at a certain point on the follow-through of the swing. The body part tracker 102 can determine a prescribed sequence for a plurality of areas of interest between the first area of interest and ending with the last area of interest. In an aspect, the body part tracker 102 can assign a plurality of consecutive numbers to the areas of interest in the prescribed sequence, starting with 1 for the first area of interest, 2 for the next area of interest in the sequence, and ending with some N for the last area of interest. In an aspect, the body part tracker 102 can identify a fixation of the first part (e.g., one or more eyes). In an aspect, if the fixation of the first part is determined to be in the start (first) area of interest, then the body part tracker 102 can begin the tracking one or more body parts (e.g., eye, hand, feet, combinations thereof, and the like). In an aspect, the body part tracker 102 can conclude tracking when the body part tracker 102 determines the first part (e.g., one or more eyes) is fixated/positioned in the end (last) area of interest.

At step 402, a plurality of metrics based on the received position data of the sequence of movements can be determined. The first plurality of metrics can include a tempo, a total backtrack duration, a backtrack count, a fixation mean, a fixation maximum, a uniformity, a non-uniformity, a velocity, an acceleration, a range of motion, beats per unit time (e.g., minute), a vibration spectrum, note accuracy, an audio quality, and the like. In an aspect, the plurality of metrics can be determined by a data collector 106 that receives the position data of the first part from a body part tracker 102. In an aspect the data collector 106 can receive position data from an object (e.g., tool 104).

At step 403, a level of proficiency of the user performing the task can be determined using a trained classifier (e.g., trained classifier 108) based on the plurality of metrics. In an aspect, the systems and methods described herein can use the trained classifier 108 as a substitute for human evaluation. In an aspect, the trained classifier 108 can receive data from a body part tracker 102 and determine metrics to evaluate a performance. In an aspect, the trained classifier 108 can receive position data from a body part tracker 102 and determine metrics that approximate metrics a human evaluator may use to evaluate a performance. For example, the trained classifier 108 can use a plurality of metrics related to a piano player's eyes to evaluate the piano player's ability to sight-read music. For example, the plurality of metrics extracted by the trained classifier 108 for evaluating a piano player's ability to sight-read music can comprise one or more of, backtrack duration, backtrack count, fixation mean, fixation maximum, non-uniformity, read ahead, and note accuracy. As an example, the trained classifier-extracted metric of backtrack duration and backtrack count can serve as a proxy for the human-extracted metric of audible regressions. As an example, the trained classifier-extracted metrics of fixation mean and fixation maximum can serve as a proxy for the human-extracted metrics of inverse of tempo and pauses or tempo diversions. In an aspect, the metrics of read ahead and note accuracy can be determined by a trained classifier 108. Therefore, the trained classifier 108 can remove the need for a human expert.

In an aspect, a plurality of metrics can be used as heuristically determined features of a model in training a trained classifier 108. In an aspect, the trained classifier 108 can receive position data and a corresponding human score, and determine the metrics to extract by model fitting the received position data. Once finalized, the trained classifier 108 can be used to automatically score user performances. The trained classifier 108 can take the set of metrics from a user performance and will output a top level score, as well as metric specific scores, similar to what a human expert evaluator would provide, but without requiring the involvement of such an expert evaluator

In an aspect, when determining a level of proficiency, the trained classifier 108 can compare the determined plurality of metrics with a predetermined pattern. The trained classifier 108 can assign a score for each of the plurality of metrics based on the comparison with the predetermined pattern. The trained classifier 108 can then determine an overall score for the ability level of the user to carry out the task based on the assigned scores. In an aspect, the scores are based on a prediction model, where the plurality of metrics of the user is determined from the body part tracker 102. The score can then be determined based on an algorithm that considers the plurality of metrics in the context of the prediction model. The prediction model can be further built by fitting the plurality of metrics against predetermined scores to assign a score. This score can in turn be added to the prediction model to determine another score for another set of metrics.

In an aspect, the methods can further comprise tracking a performance of an instrument and evaluating the tracked instrument performance. For example, when tracking performance of a musical instrument, the data collector 106 can determine note accuracy, tone accuracy, volume accuracy, combinations thereof and the like. The data collector 106 can compare audio recordings, instrument data from a MIDI instrument, combinations thereof, and the like to a prerecorded and/or expected notes of the task (e.g., musical piece) stored in the data collector 106.

The methods can further comprise updating information displayed to the user in real time, based on the score determined in order to change the sequence and duration of the user's fixations to more closely resemble the prescribed sequence and set of durations, for example as intended for a particular ideal performance of the task at hand.

The methods can further comprise determining an evaluation score for the user's performance across a plurality of sessions. The evaluation score can show improvement in the ability to perform the task at hand in terms of approaching the prescribed sequence and set of durations as intended for a particular ideal performance of the task at hand.

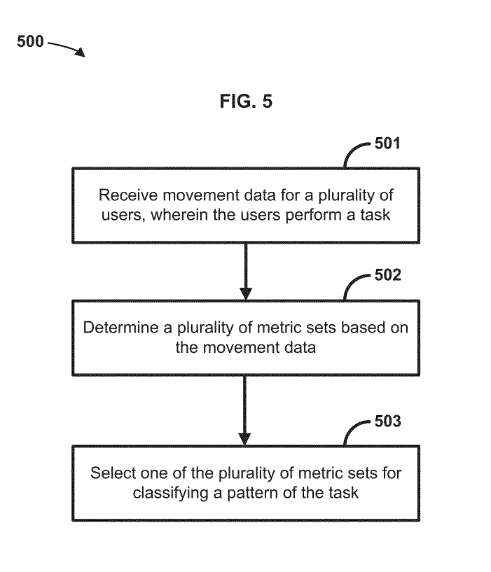

FIG. 5 is a flowchart illustrating an example method 500 for evaluating performance, according to various aspects. At step 501, movement data for a plurality of users can be received. In an aspect, the movement data can comprise data relating to the movement of one or more body parts, movement of one or more tools, combinations thereof, and the like. For example, the movement data can comprise eye movement data. In an aspect, the received movement data for a plurality of users can comprise a plurality of fixation points associated with the plurality of users and a plurality of times associated with the plurality of fixation points.

At step 502, a plurality of metric sets can be determined based on the movement data. In an aspect, the plurality of metric sets can comprise, but are not limited to, one or more metrics of: a backtrack duration, a backtrack count, a fixation mean, a fixation maximum, a uniformity, a non-uniformity, a velocity, a spatial factor, an acceleration, a range of motion, beats per unit time, a vibration spectrum, a note accuracy, and an audio quality. In an aspect, the metrics can be determined by a data collector 106 that receives the position data of the first part from a body part tracker 102. In an aspect the data collector 106 can receive position data from an object (e.g., tool 104).

The methods can further comprise receiving a plurality of performances of an instrument. For example, when tracking performance of a musical instrument, the data collector 106 can determine note accuracy, tone accuracy, volume accuracy, combinations thereof and the like. The data collector 106 can compare audio recordings, instrument data from a MIDI instrument, combinations thereof, and the like to prerecorded and/or expected notes of the task (e.g., musical piece) stored in the data collector 106.

At step 503, one of the plurality of metric sets can be selected for classifying a pattern. In an aspect, one of the plurality of metric sets can be an “ideal” metric set for classifying a pattern. The pattern can be used by a trained classifier (e.g., trained classifier 108) when determining the performance level of a user performing a task. In an aspect, one or more of the plurality of metric sets can be selected by evaluating each of the plurality of metric sets. For example, each of the plurality of users who performs the task can cause to generate one or more metrics such as, but not limited to, backtrack duration, backtrack count, fixation mean, fixation maximum, non-uniformity, and note accuracy. In an aspect, when evaluating the plurality of metric sets, the data collector 106 can compare each metric and set of metrics to determine a pattern for the trained classifier 108 to use when determining a level of proficiency. For example, metrics or metric sets that are consistent with each other can be determined to be “ideal” metrics or metric sets and selected to create a pattern. In another example, a majority of the metrics or metric sets that are consistent with each other can be selected for classifying the pattern.

In an aspect, provided are exemplary methods and systems for evaluating performance related to the eye. However, the present disclosure is not limited to analysis of the eye. Tracking of other body parts is also specifically contemplated.

A skilled piano player can decipher and play a musical piece the player has never seen before (a skill known as sight-reading). An eye tracking-enabled computer can help a student assess the student's sight-reading abilities, and can advise the student on how to improve. The approach can be extended to any musical instrument. For keyboard players, a MIDI keyboard with the appropriate software to provide information about note accuracy and timing can complement feedback from an eye tracker to enable more detailed analysis and advice.

Sight-reading is the ability of a musician to play a musical score upon seeing the score for the first time. Sight-reading can be of practical importance to professional players, who can be required to play a piece with very little time to practice the piece, for example to record music in a studio. Alternatively, sight-reading can be used as a way to test music students on integrating several facets of the students' technical music knowledge.

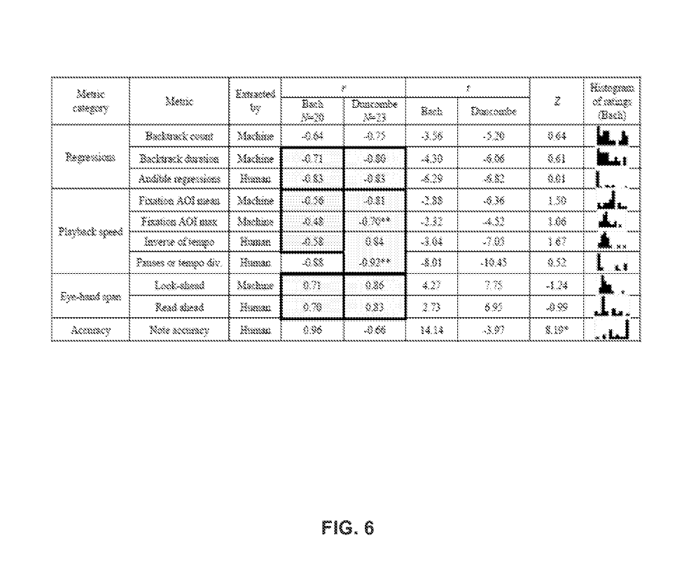

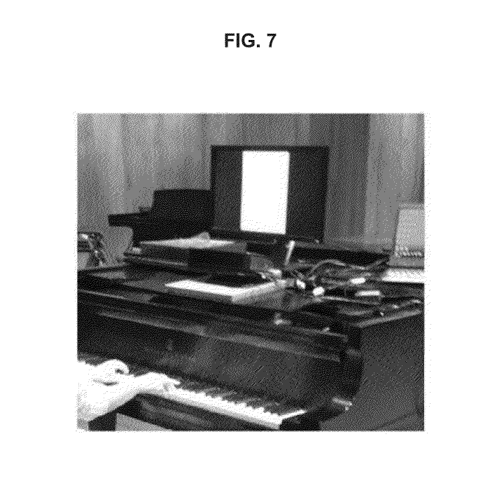

FIG. 6 illustrates a table with results from application of the methods and systems. One skilled in the art will recognize that the application shown in FIG. 6 is only an example of the systems and methods described herein, and is not intended to limited the scope of the attached claims. In the example, the systems and methods described herein evaluated sight-reading abilities of piano player subjects. In the example, a system comprised a piano which was used as a tool (e.g., tool 104 of FIG. 1) of a subject. The system also comprised an eye tracker which was used as a body part tracker (e.g., body part tracker 102). Also, a laptop computer was used as a data collector (e.g., data collector 106). A musical score for a musical piece was displayed on a visual display device for the subjects to sight-read. An example setup of the system is illustrated in FIG. 7.

In the example, two musical pieces were selected to be performed by the subjects: a four part chorale and a non-chorale musical piece. The four-voice chorale was chosen because it poses special issues for intermediate music readers. For example, it involves several voices (chordal texture) even though it is not a polyphonic piece. Furthermore, chorales can be used to evaluate music reading ability of students. As an example, the non-chorale musical piece was selected as an easier musical example, to observe differences (if any) in reading music that is less challenging, and with a more linear texture.

The piano was the primary instrument for all but three subjects in the study. In the example, subjects for which piano was the secondary instrument were not able to play the chorale piece with both hands. In the example, none of the subjects were familiar with either of the two musical pieces.

Subjects were seated at the piano. As an example, a subject was allocated approximately 30 seconds to study (visually only) a paper copy of the musical score the subject was about to be evaluated upon. As such, musicians can be asked to participate, formally or informally, in performing a musical piece after only a cursory study of the music score.

In the example, an eye-tracker calibration routine was completed by each subject. In the example, after successfully completing the calibration, the music score was displayed on a monitor and the subject was asked to play (and read) the music at the piano as carefully and accurately as possible; the subject established a tempo (speed) for completion of the exercise. In the example, while the tempo was not set or specified, the subject understood that “successful performance” included choosing an appropriate tempo for the piece, while ensuring good note accuracy (within the appropriate musical and stylistic considerations). A compromise between tempo and note accuracy may result in a slightly slower or “cautious” tempo reading. In the example, all subjects were able to produce a reading that had acceptable “artistic merit” under the circumstances. In the example, eye gaze data of each subject was collected by the eye tracker and made anonymous, then the collected anonymized eye gaze data to be further processed.

In addition to collecting the eye gaze data, also two types of human metrics were provided for each subject. In the example, a first type of human metric was an overall metric, scored on a scale of 1 to 10 and representing a holistic evaluation of the subject's sight-reading ability. In the example, the actual range of values was 3 to 10, with more values towards the high end. In the example, the second type of human metric was estimated by looking at a video-recording of the eye tracking session. In the example, the metrics included: tempo (higher is better), note accuracy (higher is better), number of audible regressions (lower is better), number of pauses or tempo diversions (lower is better), and read ahead (the number of beats between the notes being looked at and the notes played, also known as eye-hand span; higher is better). In the example, in evaluating machine-extracted scores, correlations for machine-extracted scores were compared with correlations for the equivalent human task-related ratings.

Cross-contamination of human-extracted metric was avoided by having the human expert estimate the overall performance first, based on a holistic evaluation of the subject's sight-reading ability. In the example, after the human expert estimated the overall performance, the human expert then rated the individual task-related player abilities based on the eye gaze data. In the example, the data processing of the machine-extracted features was performed by people other than the human expert. In the example, the people that performed the data processing of the machine-extracted features were not proficient piano players and were not aware of the identities of the various subjects involved.

The raw eye gaze data was processed to determine metrics that are related to the human task-related metrics above. In the example, machine-extracted metrics were designed to be similar to the heuristics the human experts use. In the example, areas of interest (AOIs) were defined to coincide with each measure in each of the two scores. In the example, gaze data can be exported from an eye tracking software (e.g., Tobii Studio).

In an example, a session can start with a first fixation on AOI 1 (a first measure), and end with a last fixation on the highest numbered AOI for the piece (assuming AOI numbering that follows the sequence of musical reading). In the example, duration estimates can be correlated with overall player metrics. In the example, as shown in FIG. 6, correlation coefficients are not statistically different between the two music scores or between the human- and machine-extracted values at p=0.05.

FIG. 6 shows a side by side comparison of the correlation values for an overall human rating and machine rating based on machine-extracted metrics grouped by category as disclosed herein. In the example, the category without a machine extracted metric is note accuracy. In another example, note accuracy can be a machine extracted metric by using a MIDI keyboard and note accuracy software. In the example, the note accuracy software can read the MIDI keyboard input and compare the input to the notes on the musical score. The comparison can indicate the note accuracy as, for example, a percentage of notes played correctly.

The results in FIG. 6 indicate that all correlation coefficients in the example (for both human- and machine-extracted metrics) are statistically significant (non-zero), |t|>2.10 for the chorale and |t|>2.08 for the non-chorale. A comparison of the correlation coefficients in the example for the two musical pieces shows that the differences in the two pieces are not statistically significant (|Z|<1.96). The only metric in the example for which correlation coefficients for the two musical pieces differ is that of note accuracy. Because the eye tracking data in the example did not include such information, only a human derived metric was available in the example and the correlation for the chorale is much higher than that for the non-chorale.

All other metrics in the example include both human- and machine-extracted metrics, compared side by side. Human-extracted metrics in the example have somewhat higher correlation with the overall player rating (by the human expert), as compared to the correlation for machine-extracted metrics. In the example, the correlation for audible regressions for the chorale was −0.83, while backtrack duration correlates at a −0.71 level and backtrack count correlates only at a −0.64 level. In the example, a z-test shows that correlation values for machine-extracted metrics are statistically similar to those for human-extracted metrics.

In the example, all metrics correlate relatively well with each other, with the lowest correlation values at 0.41. In the example, the AOI related machine-extracted metrics correlate very well (0.80) with the inverse tempo (human-extracted).

Machine-extracted features of the gaze path of sight-readers of various piano playing abilities are well correlated with the overall player rating scored by a human expert. In the example, the comparison was against task-related metrics extracted by a human expert. In the example, the correlation levels for both human- and machine-extracted features are not statistically distinct at a p=0.05 level, across a range of metric types. In the example, the only metric for which the eye tracking data provide no information was note accuracy. In another example for keyboard players, using a MIDI-enabled keyboard and appropriate software would also allow for machine-extracted information about note accuracy. A proficient player may be able to self-diagnose note accuracy.

The results of the example indicate that machine extraction of sight-reading metrics from eye tracking data can be used to assess the sight-reading abilities of a musical instrument performer.

While the methods and systems have been described in connection with preferred embodiments and specific examples, it is not intended that the scope be limited to the particular embodiments or performance levels set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

Throughout this application, various publications are referenced. The disclosures of these publications in their entireties are hereby incorporated by reference into this application in order to more fully describe the state of the art to which the methods and systems pertain.

It will be apparent to those skilled in the art that various modifications and variations can be made without departing from the scope or spirit of the disclosed systems and methods. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method comprising:
receiving, by a computer system, first movement data of a first part of a user, wherein the user performs a task;
determining, by the computer system, a first plurality of metrics based on the first movement data of the first part of the user; and
determining, by the computer system, a level of proficiency of the user to perform the task using a trained classifier based on the first plurality of metrics.

2. The method of claim 1, further comprising:
receiving, by the computer system, second movement data of a second part of the user that corresponds to movement of the first part of the user; and
determining, by the computer system, a second plurality of metrics based on the second movement data of the second part of the user.

3. The method of claim 2, further comprising:
determining, by the computer system, the level of proficiency of the user to perform the task using the trained classifier based on the first plurality of metrics and the second plurality of metrics.

4. The method of claim 1, further comprising:
tracking, by the computer system, one or more spatial factors of an instrument;
determining, by the computer system, a third plurality of metrics based on the one or more spatial factors; and
determining, by the computer system, the level of proficiency of the user to perform the task using the trained classifier based on the first plurality of metrics and the third plurality of metrics.

5. The method of claim 1, further comprising determining, by the computer system, using the trained classifier based on the first plurality of metrics, the task being performed by the user.

6. The method of claim 1, wherein the first part of the user comprises one or more eyes.

7. The method of claim 2, wherein the second part of the user comprises one or more hands.

8. The method of claim 1, wherein the first plurality of metrics is one or more of a backtrack duration, a backtrack count, a fixation mean, a fixation maximum, a uniformity, a non-uniformity, a velocity, a spatial factor, an acceleration, a range of motion, beats per unit time, a vibration spectrum, a note accuracy, and an audio quality.

9. The method of claim 1, wherein determining, by the computer system, a level of proficiency of the user to perform the task using a trained classifier based on the first plurality of metrics, comprises using a machine-learning based classifier that was trained on a set of one or more users each having a respective level of proficiency.

10. The method of claim 3, wherein classifying, by the computer system, a level of proficiency of the user on the task using a trained classifier based on the first plurality of metrics and the second plurality of metrics further comprises:
detecting movement of the second part relative to one or more user devices; and
determining whether the performed activity of the second part of the user is an expected activity based on the first plurality of metrics and the movement of the second part relative to one or more user devices.

11. The method of claim 1, wherein the task is one or more of, using a tool, using an instrument, using a musical instrument, playing a video game, reading text, typing text, reading a foreign language, typing a foreign language, and interacting with a user device via a user interface.

12. A method, comprising:
receiving, by a computer system, position data of a sequence of movements of a first part of a user, wherein the user is performing a task;
determining, by the computer system, a plurality of metrics based on the position data of the sequence of movements; and
determining, by the computer system, a level of proficiency of the user performing the task using a trained classifier based on the plurality of metrics.

13. The method of claim 12, wherein receiving, by the computer system, position data of the sequence of movements of the first part of the user comprises:
determining a prescribed sequence for a plurality of areas of interest in a visual field of the user between a start area of interest and ending with a last area of interest; and
tracking a duration of a fixation of the first part of the user at each area of interest of the plurality of areas of interest in the visual field, wherein the first part of the user is one or more eyes.

14. The method of claim 13, wherein receiving, by the computer system, position data of the sequence of movements of the first part of the user comprises:
identifying a fixation of the first part of the user,
beginning the tracking when the fixation of the eye is determined to be in the first area of interest; and
concluding the tracking when the fixation of the eye is determined to be in the last area of interest.

15. The method of claim 13, wherein the first plurality of metrics is one or more of a backtrack duration, a backtrack count, a fixation mean, a fixation maximum, a uniformity, a non-uniformity, a velocity, a spatial factor, an acceleration, a range of motion, beats per unit time, a vibration spectrum, a note accuracy, and an audio quality.

16. The method of claim 12, wherein determining, by the computer system, a level of proficiency of the user performing the task using a trained classifier based on the determined plurality of metrics comprises:
comparing the plurality of metrics with a predetermined pattern;
assigning a score for each of the plurality of metrics based on the comparison with the predetermined pattern; and
determining an overall score for the task based on the assigned scores.

17. A method, comprising:
receiving, by a computer system, movement data for a plurality of users, wherein the users perform a task;
determining, by the computer system, a plurality of metric sets based on the movement data; and
selecting, by the computer system, at least one of the plurality of metric sets for classifying a pattern of the task.

18. The method of claim 17, wherein the movement data comprises eye movement data.

19. The method of claim 18, wherein receiving, by the computer system, movement data for a plurality of users further comprises:
receiving a plurality of fixation points associated with the plurality of users; and
receiving a plurality of times associated with the plurality of fixation points.

20. The method of claim 17, wherein selecting, by the computer system, at least one of the plurality of metric sets for classifying the pattern of the task, comprises selecting one or more ideal metric sets.
